(19) United States
(12) Patent Application Publication
(10) Pub. No.: US 2026/0019280 A1
(43) Pub. Date: Jan. 15, 2026

(54) COMMUNICATION SYSTEM, CERTIFICATE AUTHORITY, AND METHOD

(71) Applicant: Kabushiki Kaisha Toshiba, Tokyo (JP)

(72) Inventor: Yasuyuki TANAKA, Kawasaki (JP)

(73) Assignee: Kabushiki Kaisha Toshiba, Tokyo (JP)

(21) Appl. No.: 19/223,301

(22) Filed: May 30, 2025

(30) Foreign Application Priority Data
Jul. 9, 2024 (JP) 2024-110315

(51) Int. Cl. H04L 9/32; G06Q 30/04

(52) U.S. Cl. CPC H04L 9/3263; G06Q 30/04

(57) ABSTRACT

A communication system includes a communication device, a terminal device, and a certificate authority. The communication device transmits a certificate signing request to the terminal device, the certificate signing request requesting issuance of a certificate used by the communication device to execute communication with the first server device. The terminal device transmits the certificate signing request transmitted from the communication device to the certificate authority. The certificate authority issues a certificate in response to the certificate signing request transmitted from the terminal device.

### CROSS-REFERENCE TO RELATED APPLICATION(S)

This application is based upon and claims the benefit of priority from Japanese Patent Application No. 2024-110315, filed Jul. 9, 2024, the entire contents of which are incorporated herein by reference. This application is further related to U.S. application Ser. No. 19/060,055 filed Feb. 21, 2025, which is incorporated herein by reference.

### FIELD

Embodiments described herein relate generally to a communication system, a certificate authority, and a method.

### BACKGROUND

In a technology called Internet of Things (IoT), various IoT services can be realized by connecting an edge device (communication device) to a network.

Incidentally, in order for the edge device to execute communication with a server device or the like that provides an IoT service via a network, a certificate (for example, a certificate for a public key of the edge device in a public key encryption scheme) for guaranteeing security in the communication is required. However, it takes time and effort to issue the certificate on a user side that owns the edge device, for example.

### BRIEF DESCRIPTION OF THE DRAWINGS

FIG. 1 is a diagram showing an example of a system configuration of a communication system according to a first embodiment.

FIG. 2 is a diagram showing an example of a functional configuration of an edge device.

FIG. 3 is a diagram showing an example of device information.

FIG. 4 is a diagram showing an example of a functional configuration of a user terminal.

FIG. 5 is a diagram showing an example of user information.

FIG. 6 is a diagram showing an example of server information.

FIG. 7 is a diagram showing an example of a functional configuration of a certificate authority.

FIG. 8 is a diagram showing an example of a hardware configuration of an edge device.

FIG. 9 is a sequence chart showing an example of a processing procedure of the communication system.

FIG. 10 is a view showing an example of a device confirmation screen.

FIG. 11 is a diagram showing an example of verification information.

FIG. 12 is a diagram showing another example of verification information.

FIG. 13 is a diagram showing still another example of verification information.

FIG. 14 is a diagram showing still another example of verification information.

FIG. 15 is a diagram showing an example of issuance history information.

FIG. 16 is a diagram showing an example of billing process information.

FIG. 17 is a sequence chart showing another example of the processing procedure of the communication system.

FIG. 18 is a diagram showing an outline of issuance of a public key certificate in a comparative example of the present embodiment.

FIG. 19 is a diagram showing an outline of issuance of a public key certificate in the present embodiment.

FIG. 20 is a diagram showing an example of a system configuration of a communication system according to the second embodiment.

FIG. 21 is a diagram showing an example of a functional configuration of a user terminal.

FIG. 22 is a sequence chart showing an example of a processing procedure of the communication system.

### DETAILED DESCRIPTION

In general, according to an embodiment, a communication system according to an embodiment includes a communication device, a terminal device (terminal), and a certificate authority. The communication device transmits, to the terminal device (terminal), a certificate signing request for requesting issuance of a certificate used by the communication device to execute communication with a first server device. The terminal device transmits the certificate signing request transmitted from the communication device to the certificate authority (certificate authority circuitry). The certificate authority issues the certificate in response to a certificate signing request transmitted from the terminal device and executes a billing process for billing for the issue of the certificate.

Hereinafter, each embodiment will be described with reference to the drawings.

### First Embodiment

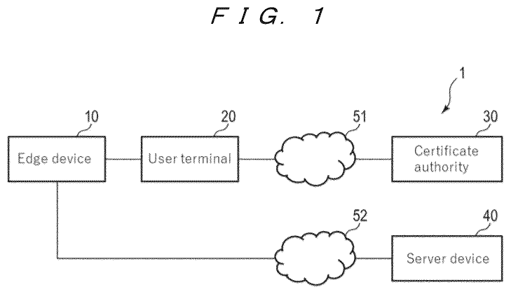

First, a first embodiment will be described. FIG. 1 shows an example of a system configuration of a communication system according to the present embodiment. As illustrated in FIG. 1, the communication system 1 includes an edge device 10, a user terminal 20 (client terminal), a certificate authority 30, and a server device 40.

The edge device 10 is a device used in a technology called IoT, and is equipped with a host controller configured to control the operation of the edge device 10 and a communication device (communication circuitry) configured to provide a communication function to the edge device 10.

The host controller and the communication device are connected via connection interfaces provided in the edge devices 10, such as USB-connectors or pin slot connectors, and communication may be performed between the host controller and the communication device in a serial manner, using protocols such as I2C (“Inter-Integrated Circuit” protocol), UART (“Universal Asynchronous Receiver Transmitter” protocol), and SPI (“Serial Peripheral Interface” protocol), or in a parallel manner.

In the present embodiment, the edge device 10 may be simply referred to as a communication device, includes an IoT device, a personal computer (PC), a gateway, or the like. The edge device 10 operates as a part of an application system for providing various IoT services by executing communication with the server device 40. However, the edge device 10 in the present embodiment is in a factory shipment state, and thus the settings necessary for executing communication with the server device 40 are not performed. The edge device 10 in the factory shipment state may be a device that has been used for another purpose in the past and then brought into the factory shipment state (that is, initialized) by a predetermined operation.

The user terminal 20 may be implemented as a handheld terminal such as a smartphone or a tablet terminal used by a user (owner of the edge device 10) who owns the edge device 10, for example, but may be a terminal device of another form such as a PC. The user terminal 20 includes a user interface that receives an input from a user and presents information to the user. In the present embodiment, a user who owns the edge device 10 uses the user terminal 20, but the user who uses the user terminal 20 may be different from the user who owns the edge device 10.

The certificate authority (authentication device) 30 is an information processing device configured to issue a certificate used for the edge device 10 to communicate with the server device 40. Specifically, when a public key encryption scheme is adopted to ensure security in communication performed between the edge device 10 and the server device 40, the certificate authority 30 issues a certificate for the public key of the edge device 10 in the public key encryption scheme (a public key certificate of the edge device 10). When the public key certificate issued by the certificate authority 30 is registered in the edge device 10, the edge device 10 can communicate with the server device 40 using the public key certificate.

The server device 40 operates to provide various IoT services by executing communication with the edge device 10. Specifically, the server device 40 may operate to register the sensor data collected by the edge device 10 in the server device 40, or may operate to issue a command to the edge device 10 and cause the edge device 10 to execute a predetermined process. Further, the server device 40 may transmit firmware or software operating on the edge device 10 to the edge device 10 and instruct the edge device 10 to update the firmware or the software.

The processing of the server device 40 described above may be executed on a server computer managed in an on-premise manner in a base such as an office, or may be executed on a virtual machine implemented on the computer. The processing of the server device 40 may be executed on a cloud board in a communication network provided by a cloud service provider or the like or on the Internet.

Note that a communication scheme applied to communication between the edge device 10 and the user terminal 20 illustrated in FIG. 1 may be a wireless communication scheme or a wired communication scheme. As a wireless communication scheme, for example, Bluetooth (registered trademark), Wi-Fi (registered trademark), ZigBee (registered trademark), or infrared communication may be used, but the wireless communication scheme is not limited thereto. The wired communication scheme may be Ethernet (registered trademark), serial communication using a universal asynchronous receiver transmitter (UART), a controller area network (CAN), or the like, but is not limited thereto.

The user terminal 20 and the certificate authority 30 shown in FIG. 1 are connected to each other via a network 51 so as to be able to communicate with each other. The edge device 10 and the server device 40 illustrated in FIG. 1 are communicably connected to each other via a network 52.

The communication scheme applied to the communication between the user terminal 20 and the network 51 and the communication scheme applied to the communication between the edge device 10 and the network 52 may be a wireless communication scheme or a wired communication scheme, similarly to the communication scheme applied to the communication between the edge device 10 and the user terminal 20 described above. The same applies to a communication scheme applied to communication between the certificate authority 30 and the network 51 and a communication scheme applied to communication between the server device 40 and the network 52.

The network 51 may be a small-scale closed network such as a local area network (LAN), a wide-area closed network such as a wide area network (WAN), or an open network such as the Internet. The user terminals 20 perform communication based on, for example, WiFi or a cellular phone communication scheme (LTE, 5G, or the like) in order to connect to the network 51, but may be configured to perform communication based on another standard. The network 51 has been described here, but the same applies to the network 52. The networks 51 and 52 may be different networks or the same network.

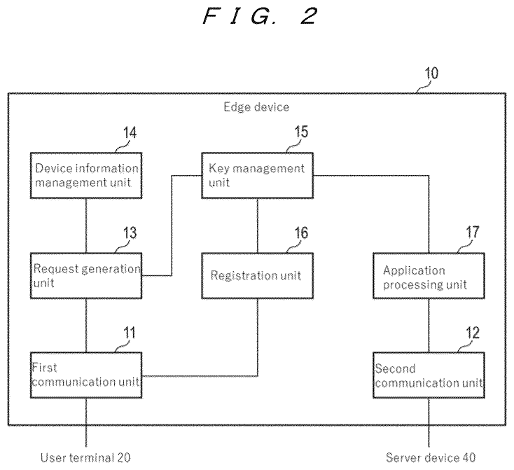

FIG. 2 shows an example of a functional configuration of the edge device 10 shown in FIG. 1. As illustrated in FIG. 2, the edge device 10 includes a first communication unit 11, a second communication unit 12, a request generation unit 13, a device information management unit 14, a key management unit 15, a registration unit 16, and an application processing unit 17.

The first communication unit 11 communicates with the user terminal 20 in accordance with a predetermined communication scheme. The second communication unit 12 communicates with the server device 40 via the network 52.

Although the first and second communication units 11 and 12 are shown as independent and separate functional units in FIG. 2, the first and second communication units 11 and 12 may be realized as a single functional unit. The communication scheme for the first communication unit 11 to perform communication may be different from or the same as the communication scheme for the second communication unit 12 to perform communication.

The request generation unit 13 generates a certificate signing request for requesting issuance of a public key certificate in accordance with an instruction from the user terminal 20 described later. The certificate signing request generated by the request generation unit 13 is transmitted to the user terminal 20 via the first communication unit 11.

The device information management unit 14 manages information (hereinafter, referred to as device information) related to the edge device 10.

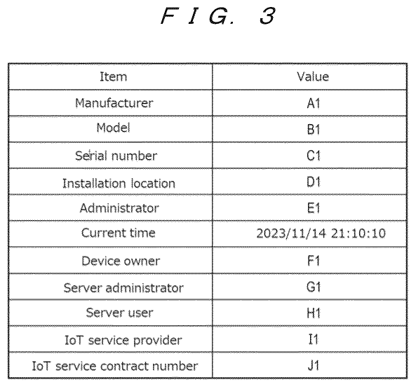

FIG. 3 shows an example of the device information. In the example illustrated in FIG. 3, the device information includes, for example, a manufacturer, a model, a serial number, an installation location, an administrator, and a current time and/or date of the edge device 10.

The manufacturer, the model, and the serial number are, for example, information embedded in advance at the time of manufacturing the edge device 10 (that is, information registered in advance in the edge device 10). The installation location and the administrator are information provided from the user terminal 20, for example. The current time is initialized by information provided from the user terminal 20, for example, and is automatically updated with the passage of time.

Further, the device information includes, for example, an owner who owns the edge device 10 (device owner), an administrator who manages the server device 40 (server administrator), a user who uses the server device 40 (server user), a provider who provides the IoT service (IoT service provider), and a number assigned to an end user who has concluded a contract with the IoT service provider to use the IoT service (IoT service contract number).

At least some of the device owner, the server administrator, the server user, the IoT service provider, and the IoT service contract number may be, for example, information embedded in advance at the time of manufacturing the edge device 10 or may be information registered (set) after the edge device 10 is shipped from a factory.

In FIG. 3, the device information is described as including the manufacturer, model, serial number, installation location, administrator, current time, the user, the server administrator, the server user, the IT service provider, and the IoT service contract number, but the device information may omit some of or all of these pieces of information, or may include additional information (for example, model number, hardware version, and the like).

In the device information illustrated in FIG. 3, for example, the server administrator may be a manufacturer of the server device 40, a cloud infrastructure provider, or the like. The server user may be the same as an IoT service provider that provides an IoT service using the server device 40.

The key management unit 15 manages a public key and a secret key (key pair) of the edge device 10 in the public key encryption scheme. The certificate signing request generated by the request generation unit 13 includes the public key of the edge device 10 managed by the key management unit 15.

Here, the key pair of the edge device 10 may be generated in response to an instruction from the request generation unit 13 when the request generation unit 13 generates the certificate signing request but may be generated when the power of the edge device 10 in a factory shipment state is turned on, for example. The key pair of the edge device 10 may be generated in accordance with an instruction from the user terminal 20. Further, the key pair of the edge device 10 may be held in advance inside the edge device 10. In addition, when the key management unit 15 is implemented as a security module of hardware such as a secure element, the key pair of the edge device 10 may be generated by the hardware.

Although the key management unit 15 is described as mainly managing the key pair of the edge device 10, the key management unit 15 may execute encryption processing and signature processing based on the public key encryption scheme. The registration unit 16 executes a process of registering the public key certificate issued by the certificate authority 30 in response to the certificate signing request generated by the request generation unit 13 in the edge device 10 (the key management unit 15).

The application processing unit 17 executes authentication process (hereinafter, referred to as device authentication process) for the edge device 10 with the server device 40 by using the public key certificate registered in the edge device 10.

When the edge device 10 is authenticated by executing the device authentication process (that is, when the authentication is successful), the application processing unit 17 executes communication (application communication) with the server device 40 via the second communication unit 12. The application processing unit 17 executes processing (application processing corresponding to application communication) on the edge device 10 side for providing the IoT service. In this case, the application processing unit 17 may execute processing of acquiring sensor data from a sensor mounted on the edge device 10 and transmitting the sensor data to the server device 40, for example. The application processing unit 17 may execute a command on the edge device 10 in accordance with an instruction from the server device 40 or may execute processing of operating an actuator connected to the edge device 10. Further, the application processing unit 17 may execute processing of updating firmware or software of the edge device 10 in accordance with an instruction from the server device 40.

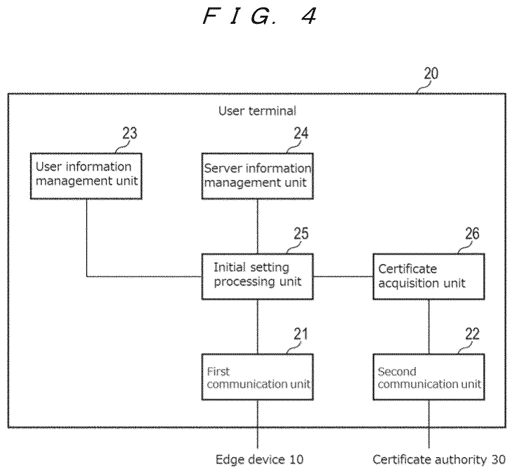

FIG. 4 shows an example of a functional configuration of the user terminal 20 shown in FIG. 1. As illustrated in FIG. 4, the user terminal 20 includes a first communication unit 21, a second communication unit 22, a user information management unit 23, a server information management unit 24, an initial setting processing unit 25, and a certificate acquisition unit 26.

The first communication unit 21 communicates with the edge device 10 in accordance with a predetermined communication scheme. The second communication unit 22 communicates with the certificate authority 30 via the network 51.

Although the first and second communication units 21 and 22 are shown as independent and separate functional units in FIG. 4, the first and second communication units 21 and 22 may be realized as a single functional unit. The communication scheme for the first communication unit 21 to perform communication may be different from or the same as the communication scheme for the second communication unit 22 to perform communication.

The user information management unit 23 manages information (hereinafter, referred to as user information) related to a user (a user who uses the user terminal 20) who owns the edge device 10.

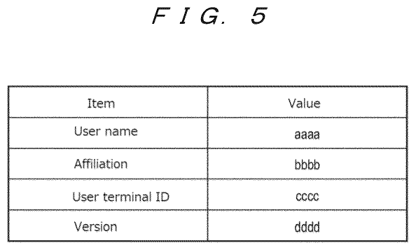

FIG. 5 shows an example of the user information. As illustrated in FIG. 5, the user information includes, for example, the user name of the user, the affiliation of the user, the user terminal ID for identifying the user terminal 20, and the version of the user terminal 20.

The user name and the affiliation are information set by the user, for example. The user terminal ID and the version are, for example, information embedded in advance at the time of manufacturing the user terminal 20 (that is, information registered in advance in the user terminal 20).

Although the user information includes the user name, the affiliation, the user terminal ID, and the version in FIG. 5, the user information may omit a part of or all of these pieces of information or may include additional information.

The server information management unit 24 manages information (hereinafter, referred to as server information) on the server device 40.

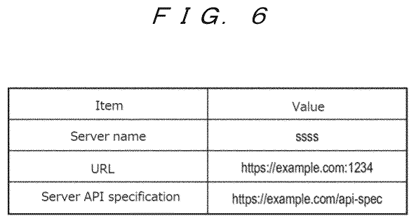

FIG. 6 shows an example of the server information. As illustrated in FIG. 6, the server information includes, for example, a server name of the server device 40, a uniform resource locator (URL) for accessing the server device 40, and a specification of an application programming interface (API) (server API specification) implemented in the server device 40.

The server name, the URL, and the server API specification may be, for example, information set by the user or information provided from the outside of the user terminal 20 (for example, the server device 40 or the like).

Although the server information is described as including the server name, the URL, and the server API specification in FIG. 6, the server information may include some of these pieces of information or may include additional information.

The initial setting processing unit 25 executes processing related to the initial setting of the edge device 10. Specifically, when the user terminal 20 is connected to the edge device 10, the initial setting processing unit 25 instructs the edge device 10 to generate a certificate signing request. The initial setting processing unit 25 provides the edge device 10 with (a part of) the user information and the server information described above as information to be set in the edge device 10 (hereinafter, referred to as setting information) in a series of initial settings of the edge device 10.

The initial setting processing unit 25 receives a certificate signing request transmitted from the edge device 10 via the first communication unit 21. The initial setting processing unit 25 verifies the received certificate signing request.

When the verification of the certificate signing request by the initial setting processing unit 25 is successful, the certificate acquisition unit 26 transmits the certificate signing request to the certificate authority 30 via the second communication unit 22. The certificate acquisition unit 26 receives the public key certificate of the edge device 10 issued by the certificate authority 30 in response to the certificate signing request via the second communication unit 22.

The public key certificate received by the certificate acquisition unit 26 in this way is passed to the initial setting processing unit 25, and is transmitted to the edge device 10 via the first communication unit 21.

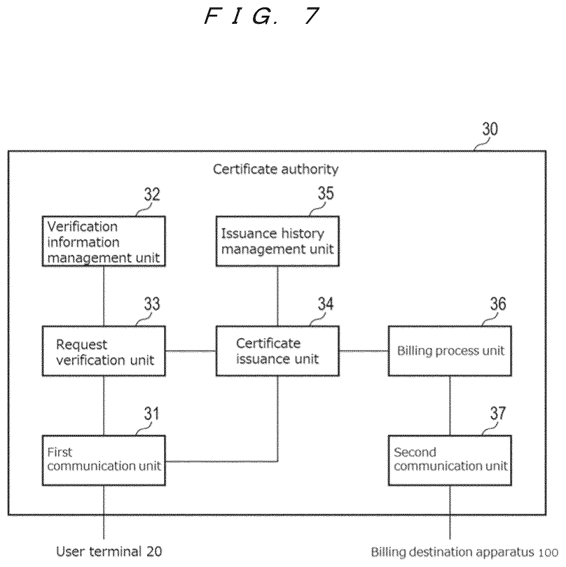

FIG. 7 shows an example of a functional configuration of the certificate authority 30 shown in FIG. 1. As shown in FIG. 7, the certificate authority 30 includes a first communication unit 31, a verification information management unit 32, a request verification unit 33, a certificate issuance unit 34, an issuance history management unit 35, a billing process unit 36, and a second communication unit 37.

The first communication unit 31 executes communication with the user terminal 20 via the network 51. The verification information management unit 32 manages information (hereinafter, referred to as verification information) used for verifying the certificate signing request transmitted from the user terminal 20. The verification information includes, for example, information about a device owned by the user to which a public key certificate can be issued.

The request verification unit 33 acquires a certificate signing request transmitted from the user terminal 20 via the first communication unit 31. The request verification unit 33 verifies whether the correspondence between the acquired certificate signing request and the user terminal 20 that is the transmission source of the certificate signing request or the user who uses the user terminal 20 is appropriate, using the verification information managed by the verification information management unit 32.

When the verification of the certificate signing request is successful, the certificate issuance unit 34 issues a public key certificate in response to the certificate signing request. The public key certificate issued by the certificate issuance unit 34 is transmitted to the user terminal 20 via the first communication unit 31.

The issuance history management unit 35 manages information (hereinafter, referred to as issuance history information) related to public key certificates issued in the past by the certificate issuance unit 34. Whether or not to issue the public key certificate may be determined based on the issue history information (that is, the history of public key certificates issued in the past) managed by the issue history management unit 35.

Here, in the present embodiment, as described above, the public key certificate is issued in the certificate authority 30, and the billing process unit 36 executes the process of billing (hereinafter, referred to as billing process) for the cost (hereinafter, referred to as certificate issuance fee) for the issuance of the public key certificate. Although the details of the billing process will be described later, in the billing process, a process is executed in which invoice data corresponding to an invoice in which the certificate issuance fee is described (that is, invoice data including the certificate issuance fee) is transmitted to a billing destination of the certificate issuance fee.

The second communication unit 37 executes communication with an information processing apparatus (hereinafter referred to as a billing destination apparatus 100) managed by the billing destination of the certificate issuance fee.

Although the first and second communication units 31 and 37 are shown as independent and separate functional units in FIG. 7, the first and second communication units 31 and 37 may be realized as a single functional unit. The communication scheme used by the first communication unit 31 to perform communication may be different from or the same as the communication scheme used by the second communication unit 37 to perform communication.

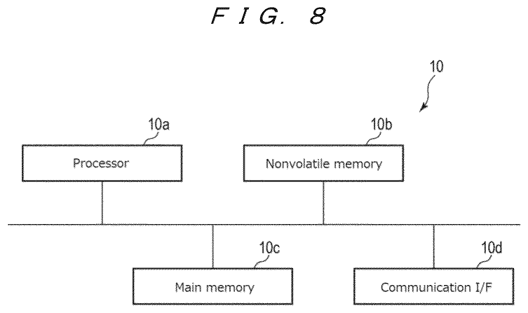

FIG. 8 shows an example of a hardware configuration of the edge device 10. As illustrated in FIG. 8, the edge devices 10 include a processor 10a, a nonvolatile memory 10b, a main memory 10c, a communication interface (I/F) 10d, and the like.

The processor 10a is configured to control the operation of each component in the edge devices 10, and may be, for example, a CPU or the like. The processor 10a may be a single processor or may be a plurality of processors. The processor 10a executes various programs that are loaded from the non-volatile memory 10b into the main memory 10c. The non-volatile memory may be implemented in any desired manner including using a semiconductor-based device such as a ROM (Read Only Memory) or a hard-disk drive, for example. The main memory may be implemented using any desired type of memory including using RAM (Random Access Memory), a hard disk drive, or a solid state drive, for example. The communication interface 10d is an interface for realizing communication with the user terminals 20 and the server device 40, for example.

In the present embodiment, some or all of the units 11 to 17 illustrated in FIG. 2 may be implemented using the processor 10a illustrated in FIG. 8 which executes a predetermined software program (application program), may be implemented by hardware such as integrated circuits (ICs), and may be implemented by a configuration in which software and hardware are combined.

Although the hardware configuration of the edge device 10 has been described here, the user terminal 20 and the certificate authority 30 may be implemented to have substantially the same hardware configuration.

In this case, some or all of the units 21 to 26 illustrated in FIG. 4 may be realized using a processor (CPU) included in the user terminal 20 which executes a predetermined program, may be realized by hardware, and may be realized by a configuration in which software and hardware are combined.

A part or all of the units 31 to 37 illustrated in FIG. 7 may be realized using a processor (CPU) included in the certificate authority 30 which executes a predetermined program, may be realized by hardware, or may be realized by a configuration in which software and hardware are combined.

In the present embodiment, the user terminal 20 further includes an input device such as a keyboard and mouse, a display device, and the like for realizing the user interface.

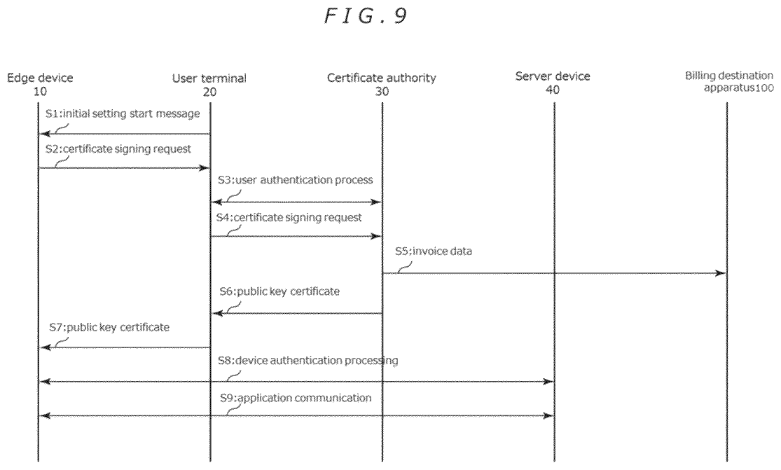

Hereinafter, an example of a processing procedure of the communication system 1 according to the present embodiment will be described with reference to a sequence chart of FIG. 9.

In the present embodiment, the edge device 10 may be implemented in a factory shipment state, and at least a public key certificate used for the edge device 10 to communicate with the server device 40 is not registered in the edge device 10 at the start of the sequence. The communication system 1 according to the present embodiment operates to realize issuance and registration of a public key certificate of the edge device 10 described above using the user terminal 20.

First, for example, when the power of the edge device 10 in a factory shipment state is turned on, the edge device 10 enters an initial setting standby state, and the edge device 10 and the user terminal 20 are communicably connected to each other in response to a user operation on the user terminal 20. When the user terminals 20 are connected to the edge devices 10 in this way, the initial setting processing unit 25 included in the user terminals 20 transmits a message requesting the start of the initial setting of the edge devices 10 (hereinafter, referred to as an initial setting start message) to the edge devices 10 via the first communication unit 21 (step S1). Note that by executing the process of step S1, the user terminals 20 instruct the edge devices 10 to generate a certificate signing request.

When the initial setting start message is transmitted in step S1, for example, the setting information (information to be set in the edge devices 10) acquired from the user information managed by the user information management unit 23 may be provided from the user terminals 20 to the edge devices 10.

Further, when the edge device 10 does not have a real-time clock, the initial setting start message may include information of the current time provided from the user or another device. According to this, the edge device 10 can set the internal clock in the edge device 10 based on the information of the current time included in the initial setting start message.

The initial setting start message may include information designated by the user. The information designated by the user includes, for example, an identifier (user ID) for identifying the user, a random character string for nonce purpose, and the like. Although it has been described that various information may be included in the initial setting start message, such information may be included in another message following the initial setting start message.

When the process of the step S1 is executed, the initial setting start message transmitted in the step S1 is received by the first communication unit 11 included in the edge devices 10, and the request generation unit 13 acquires the initial setting start message from the first communication unit 11.

The request generation unit 13 generates a certificate signing request for requesting issuance of a public key certificate in response to the received initial setting start message (i.e., an instruction to generate a certificate signing request). The certificate signing request generated by the request generation unit 13 is, for example, a CSR (Certificate Signing Request) according to PKCS #10 (RFC2986) of PKCS (Public-Key Cryptography Standards).

In the present embodiment, the certificate authority 30 executes the billing process for billing for the certificate issuance fee, and the billing process needs to be executed for the billing destination of the certificate issuance fee. Therefore, the request generation unit 13 generates a certificate signing request including information instructing a billing destination of the certificate issuance fee (hereinafter, referred to as billing destination information).

In this case, for example, the initial setting start message transmitted from the user terminals 20 in the above-described step S1 includes an instruction regarding the billing destination, and the request generation unit 13 generates a certificate signing request including the billing destination information acquired from the device information based on the instruction.

To be more specific with reference to FIG. 3, for example, when it is instructed that the billing destination is the device owner (the user who owns the edge devices 10), the request generation unit 13 acquires the device-owner “F1” from the device information and generates a certificate signing request including the device owner “F1” as the billing destination information.

For example, when it is instructed that the billing destination is the server user, the request generation unit 13 acquires the server user “H1” from the device information and generates the certificate signing request including the server user “H1” as the billing destination information.

Although the case where the billing destination is the device owner and the server user has been described here, the request generation unit 13 may generate a certificate signing request including billing destination information according to an instruction from the user terminal 20.

The billing destination may be instructed based on, for example, information held in the user terminal 20. The information held in the user terminal 20 may be, for example, information managed as a part of the user information by the user information management unit 23, or may be information held in advance in an application program executed on the user terminal 20 when the above described initial setting is performed. The billing destination may be instructed by the user who uses the user terminal 20.

Although the billing destination is described as being instructed from the user terminal 20, the billing destination may be registered (set) in advance in the edge device 10.

In addition, although it has been described that information acquired from the device information managed in the edge device 10 (device information management unit 14) is used as the billing destination information, for example, in a case where information used as the billing destination information is not managed in the device information, the edge device 10 may directly acquire (receive) the billing destination information from the user terminal 20.

Furthermore, although the description has been made assuming that the billing destination information is included in the certificate signing request, the edge device 10 (and the user terminal 20) may operate to generate the certificate signing request including the instructed information, and does not need to recognize that the information is the billing destination information (information related to the billing process).

The certificate signing request generated by the request generation unit 13 as described above is transmitted to the user terminals 20 via the first communication unit 11 (step S2).

The certificate signing request transmitted in step S2 includes the public key of the edge device 10 managed by the key management unit 15, but may further include, for example, the device information (a manufacturer, a model number, a model, a serial number, a hardware version, and the like of the edge device 10) managed by the device information management unit 14.

The certificate signing request transmitted in step S2 may include a part of various information included in the initial setting start message (for example, user information provided from the user terminal 20), the date and time when the certificate signing request is generated, and the like. According to this, by referring to (information included in) the certificate signing request, it is possible to determine the user who instructed the generation of the certificate signing request and the date and time when the certificate signing request was generated (that is, the date and time when the initial setting of the edge device 10 was started). The certificate signing request may include device information (for example, a serial number) managed by the device information management unit 14.

When the process of the step S2 is executed, the certificate signing request transmitted in the step S2 is received by the first communication unit 21 included in the user device 20, and the initial setting processing unit 25 acquires the certificate signing request from the first communication unit 21.

The initial setting processing unit 25 verifies the acquired certificate signing request. In this case, the verification of the certificate signing request succeeds when the user information provided by the user terminal 20 is included in the certificate signing request, and fails when the user information is not included in the certificate signing request, for example. Note that the certificate signing request may be verified based on other information.

The initial setting processing unit 25 passes the certificate signing request to the certificate acquisition unit 26 when the verification of the certificate signing request is successful, and discards the certificate signing request when the verification of the certificate signing request fails. When the certificate signing request is discarded, the initial setting processing unit 25 may notify the user of an error.

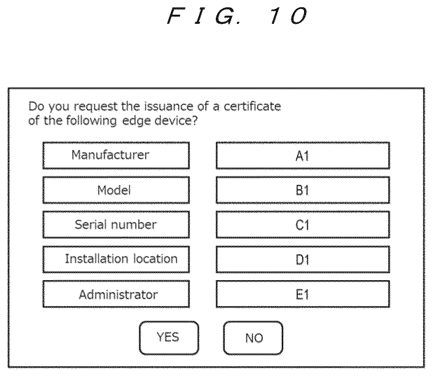

The certificate signing request may be verified by the user confirming the contents of the certificate signing request. In this case, the user terminal 20 presents the device information included in the certificate signing request to the user on a screen (hereinafter, referred to as a device confirmation screen) as illustrated in FIG. 10, for example. Accordingly, the user can confirm whether the certificate signing request received by the user terminal 20 is the certificate signing request generated by the edge device 10 intended by the user.

For example, when the device information displayed on the device confirmation screen matches the device information (e.g., the serial number) printed on the housing of the edge device 10, the user instructs to request issuance of the public key certification (i.e., to execute the processing in step S3 and subsequent steps).

When the verification of the certificate signing request is successful, the certificate acquisition unit 26 performs a user authentication process with the certificate authority 30 (the first communication unit 31) (step S3). The user authentication process corresponds to a process of transmitting, for example, a user ID, a password, and the like assigned to the user who uses the user terminal 20 (a user who owns the edge device 10) from the user terminal 20 to the certificate authority 30 and confirming whether the user is a valid user who can request issuance of a public key certificate in the certificate authority 30. Although the user ID and the password are used in the user authentication process in the above description, the user authentication process may be any process for authenticating the user (or the user terminal 20), and other information may be used.

When the user is authenticated by the process of step S3 (i.e., when the user is confirmed to be a valid user in the user authentication process), the certification acquisition unit 26 transmits a certification signing request to the certificate authority 30 via the second communication unit 22 (step S4).

When the process of the step S4 is executed, the certificate signing request transmitted in the step S4 is received by the first communication unit 31 included in the certificate authority 30, and the request verification unit 33 acquires the certificate signing request from the first communication unit 31.

The request verification unit 33 verifies the acquired certificate signing request based on the verification information managed by the verification information management unit 32. When the edge device 10 to be the target of the certificate signing request (that is, the edge device 10 capable of requesting the issuance of the public key certificate) and the attribute information of the certificate are set in advance by the user, for example, in the verification of the certificate signing request, it may be confirmed whether the edge device 10 or the attribute information is appropriate. The attribute information in this case includes, for example, information of the installation location of the edge device 10, the administrator, and the like.

The certificate signing request may be verified by checking whether the data structure of the certificate signing request or information included in the certificate signing request conforms to the specification requested by the certificate authority 30.

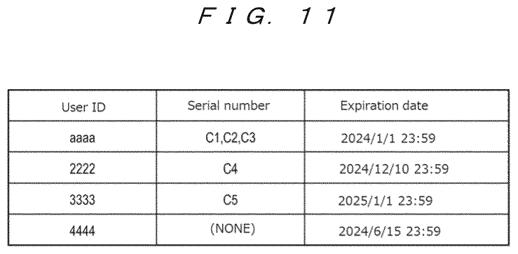

An example of the verification of the certificate signing request performed by the certificate authority 30 as described above will be described below. First, FIG. 11 shows an example of verification information. In the example illustrated in FIG. 11, the verification information includes a user ID for identifying a user, a serial number of the edge device 10 owned by the user, and an expiration date of the verification information in association with each other.

Here, if the certificate signing request acquired by the request verification unit 33 includes user information (for example, a user ID) and device information (for example, a serial number), the certificate signing request is successfully verified when the user ID and the serial number match (that is, there is verification information including the user ID and the serial number included in the certificate signing request in association with each other) as a result of comparison between the certificate signing request and the verification information. The verification of the certificate signing request fails when at least one of the user ID and the serial number does not match as a result of the comparison between the certificate signing request and the verification information (that is, when the verification information including the user ID and the serial number included in the certificate signing request in association with each other does not exist).

Although the certificate signing request includes the user information in the above description, the certificate signing request may not include the user information. The first communication unit 31 has executed the user authentication process with the user terminals 20 (the certification acquisition unit 26) in step S3 described above, and stores the user information (user IDs and the like) used in the user authentication process. Therefore, as described above, when the user information is not included in the certificate signing request, the request verification unit 33 acquires the user information provided from the first communication unit 31 and uses the user information for verification of the certificate signing request.

Note that, as described above, the validation information includes the expiration date, but validation information whose expiration date has expired may be discarded or may be updated to validation information including a new expiration date.

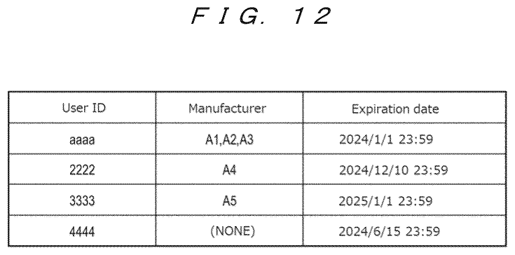

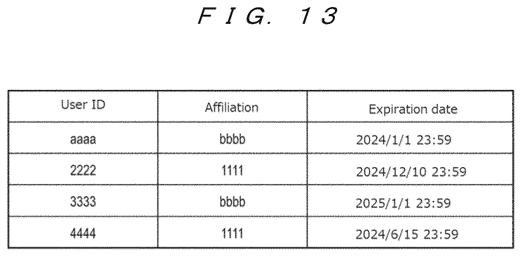

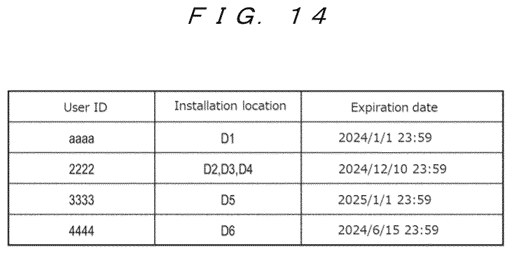

Although the verification information is described as information including the user ID and the serial number in association with each other, the verification information may be information including the user ID and the manufacturer of the edge device 10 in association with each other as shown in FIG. 12, information including the user ID and the affiliation of the user in association with each other as shown in FIG. 13, or information including the user ID and the installation location of the edge device 10 in association with each other as shown in FIG. 14. Even in the case of the verification information as illustrated in FIGS. 12 to 14, the certificate signing request can be verified by comparing the certificate signing request with the verification information.

The verification information managed by the verification information management unit 32 may be information having a data structure in which the above described FIGS. 11 to 14 are combined.

That is, in the present embodiment, it can be said that the edge device 10 capable of issuing the public key certificate is limited or designated according to the authority set in advance for the user (user terminal 20) by the above described verification information.

The request verification unit 33 passes the certificate signing request to the certificate issuance unit 34 when the verification of the certificate signing request is successful, and discards the certificate signing request when the verification of the certificate signing request fails. Note that, when the certificate signing request is discarded, the request verification unit 33 may notify the user terminal 20 (the user who uses the user terminal 20) of an error via the first communication unit 31.

As described above, when the verification of the certificate signing request is successful, the certificate issuance unit 34 takes over the process from the request verification unit 33, and issues the public key certificate of the edge device 10 in response to the certificate signing request passed from the request verification unit 33. When the public key certificate is issued by the certificate issuance unit 34 in this way, the issuance history information related to the issued public key certificate is managed by the issuance history management unit 35.

Note that the above description has been given assuming that the public key certificate is issued when the verification of the certificate signing request is successful. However, if the certificate issuance unit 34 has processed exactly the same certificate signature request as the one currently processed and/or has processed a request with exactly the same content including a time stamp and the like in the past based on the issue history information (history of public key certificates issued in the past) managed by the issue history management unit 35 and has issued a certificate at that time, the certificate issuance unit 34 may interrupt the current processing and may not issue a new public key certificate, if desired.

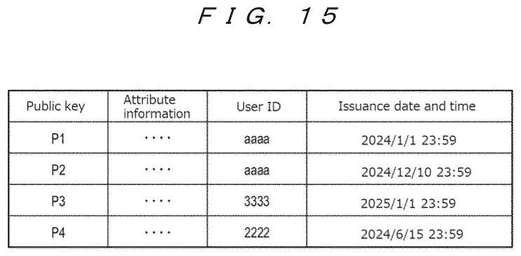

FIG. 15 shows an example of the issuance history information. As illustrated in FIG. 15, the issuance history information includes a public key for which a public key certificate has been issued in the past, attribute information of the public key certificate, a user ID for identifying a user who has requested the issuance of the public key certificate, and a date and time when the public key certificate has been issued (issuance date and time) in association with each other. The attribute information includes, for example, information such as an identifier and/or an installation location of the edge device 10.

According to the issuance history information shown in FIG. 15, the certificate issuance unit 34 can confirm whether a certificate for the same public key as the public key for which issuance of a public key certificate is requested by the certificate signing request has been issued in the past (that is, whether issuance history information including the same public key as the certificate signing request and attribute information has already been managed by the issuance history management unit 35) by referring to the issuance history information. Specifically, for example, if the certificate signing request includes the date and time when the certificate signing request is generated (hereinafter referred to as request generation date and time), when the public key and the attribute information included in the issuance history information including the issuance date and time before the request generation date and time match the public key and the attribute information included in the certificate signing request, it is found that the certificate for the same public key has been issued in the past.

When it is confirmed that a certificate for the same public key has been issued in the past, the certificate issuance unit 34 may discard the certificate signing request without issuing a public key certificate in response to the certificate signing request. In this case, the certificate issuance unit 34 may notify (the user who uses) the user terminal 20 that the certificate signing request has been discarded, or may notify an alert to the administrator of the certificate authority 30, via the first communication unit 31.

Although it has been described that a public key certificate is not issued when a certificate for the same public key has already been issued, a serial number or a random number of the public key certificate may be embedded in the attribute information (that is, the attribute information may be changed by the serial number or the random number), so that the public key certificate can be reissued even for the same public key.

When the public key certificate is issued by the certificate issuance unit 34 as described above, the billing process unit 36 receives a certificate signing request from the certificate issuance unit 34, for example, and executes billing process for billing the certificate issuance fee.

The billing process executed by the billing process unit 36 will be described below. First, the billing process unit 36 specifies a billing destination of the certificate issuance fee based on the billing destination information included in the certificate signing request. According to the example illustrated in FIG. 3 described above, the billing destination of the certificate issuance fee is one of the device owner, the server administrator, the server user, the IoT service provider, and the IoT service contract number (or the end user assigned the IoT service contract number), but may be, for example, the manufacturer of the edge device 10.

Next, the billing process unit 36 generates invoice data including the certificate issuance fee. The invoice data generated by the billing process unit 36 may be data in a PDF format or the like, for example, but may be data in another format. The generated invoice data is transmitted from the second communication unit 37 to the billing destination apparatus 100 based on the billing destination of the certificate issuance fee of the certificates specified as described above (step S5).

Note that, in a case where the billing destination of the certificate issuance fee is, for example, the device owner (the user who owns the edge device 10), and the device owner has issued the certificate using the user terminal 20 (that is, the user who uses the user terminal 20), the billing destination apparatus is the user terminal 20. In addition, in a case where the billing destination of the certificate issuance fee is, for example, a server administrator, a server user, or an IoT service provider, the billing destination apparatus is, for example, the server device 40 or another server device. Furthermore, in a case where the billing destination of the certificate issuance fee is, for example, an end user of the IoT service, the billing destination apparatus is, for example, a terminal device used by the end user.

Although the description has been made assuming that the invoice data is directly transmitted to the billing destination (billing destination apparatus 100) of the certificate issuance fee, the billing destination apparatus 100 may be a server device or the like managed by an invoice agency when billing for the certificate issuance fee through a billing agency that provides services for invoicing and collecting various fees.

Note that, in the billing process, the invoice data including the certificate issuance fee is transmitted to the billing destination, but the unit price for calculating the certificate issuance fee (fee for issuance of one public key certificate) may be common to a plurality of billing destinations, or may be different for each billing destination, for example.

The timing at which the invoice data is transmitted to the billing destination (i.e., the billing timing) may be each time a public key certificate is issued, or may be each time a predetermined number (fixed number) of public key certificates are issued. The billing timing may be each time a predetermined period (for example, one month) has passed. In FIG. 9, it is assumed that the invoice data is transmitted to the billing destination each time the public key certificate is issued.

Further, the payment method of the certificate issuance fee may be a post-payment method of paying the fee after the public key certificate is issued or may be a pre-payment method of paying the fee in advance before the public key certificate is issued.

Here, it is assumed that the billing process unit 36 stores billing process information for managing the unit price, the billing timing, and the payment method for each billing destination in advance.

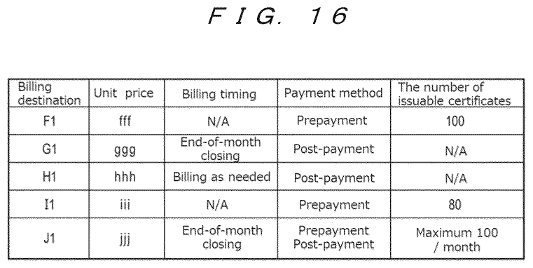

Hereinafter, an example of the billing process information will be described with reference to FIG. 16. As illustrated in FIG. 16, the billing process information includes a unit price, a billing timing, a payment method, and the number of issuable certificates in association with a billing destination.

In the example illustrated in FIG. 16, the billing process information includes a unit price “fff”, a billing timing “N/A”, a payment method “prepayment”, and the number of issuable certificates “100” in association with a billing destination “F1”. This instructs that the billing destination “F1” pays in advance a fee obtained by multiplying the unit price “fff” by the number of issuable certificates “100”. In this case, the billing destination “F1” can issue 100 public key certificates depending on the pre-paid fee, and the certificate issuance unit 34 described above issues the public key certificates when the difference between the number of issuable certificates and the number of already issued public key certificates (the number of issued public key certificates for which the billing destination is “F1”) is 1 or more. In other words, the certificate issuance unit 34 does not issue a public key certificate when the difference between the number of issuable certificates and the number of already issued public key certificates is 0 or an invalid value. When the certificate issuance unit 34 does not issue a public key certificate, the certificate issuance unit 34 notifies the user terminal 20 of an error. That is, the certificate issuance unit 34 may determine (decide) whether or not to issue a public key certificate based on the billing process information. The number of public key certificates that have already been issued can be determined by referring to the issuance history information described above. The number of already issued public key certificates may be managed in the billing process information by subtracting the number of issuable certificates associated with the billing destination “F1” each time a public key certificates for which the billing destination is “F1” is issued.

The billing process information also includes a unit price “ggg”, a billing timing “end-of-month closing”, a payment method “post-payment”, and the number of issuable certificates “N/A” in association with a billing destination “G1”. According to this, it is instructed that the billing destination “G1” pays a fee obtained by multiplying the unit price “ggg” by the number of public key certificates issued by the end of the month in post-payment. The number of public key certificates issued by the end of the month can be determined by referring to the issuance history information described above but may be managed in the billing process information. The billing process information also includes a unit price “hhh”, a billing timing “billing as needed”, a payment method “post-payment”, and the number of issuable certificates “N/A” in association with a billing destination “H1”. According to this, it is instructed that the billing destination “H1” pays a fee corresponding to the unit price “hhh” by post-payment every time a public-key certificate is issued.

The billing process information also includes a unit price “iii”, a billing timing “N/A”, a payment method “prepayment”, and the number of issuable certificates “80” in association with a billing destination “I1”. According to this, it is instructed that the billing destination “I1” pays a fee in advance obtained by multiplying the unit price “fff” by the number of issuable certificates “80”. The billing process information also includes a unit price “jjj”, a billing timing “end-of-month closing”, a payment method “prepayment/postpayment”, and the number of issuable certificates “maximum 100/month” in association with a billing destination “J1”. According to this, it is instructed that the billing destination “I1” pays a fee obtained by multiplying the unit price “jjj” by the number of issuable certificates “100” in advance, and pays a fee obtained by multiplying the unit price “jjj” by the number of public key certificates issued by the end of the month in excess of the number of issuable certificates in post-payment when public key certificates are issued in excess of the number of issuable certificates.

The billing process unit 36 can execute an appropriate billing process according to the billing destination by referring to the billing process information described above. In other words, in the present embodiment, the unit price for calculating the certificate issuance fee (the calculation method of the certificate issuance fee), the billing timing of the certificate issuance fee (the calculation timing of the certificate issuance fee or the transmission timing of the invoice data), and the payment method of the certificate issuance fee can be made different according to the billing destination.

Although not illustrated in the example of FIG. 16, the number of issuable certificates may be managed in the billing process information even when the payment method is “post-payment”. According to this, for example, by setting the number of issuable certificates according to the budget of the billing destination, it is possible to avoid issuing a number of public key certificates exceeding the budget of the billing destination (that is, billing the billing destination with a fee exceeding the budget).

In addition, although the present embodiment has been described assuming that the certificate issuance fee is billed to the billing destination specified based on the billing destination information included in the certificate signing request, an error may be notified from the certificate issuance unit 34 to the user terminal 20 when the billing destination is not included in the billing process information (that is, when the certificate authority 30 receives the certificate signing request associated with the billing destination that is not included in the billing process information).

Here, in order to execute the billing process (process of billing the certificate issuance fee), billing destination information instructing a billing destination of the certificate issuance fee is necessary. However, for example, in a case where the billing destination information is not included in the certificate signing request, the billing destination of the certificate issuance fee cannot be specified, and thus the billing process unit 36 may notify the user terminal 20 (the user who uses the user terminal 20) of an error via the first communication unit 31.

On the other hand, even when the certificate signing request does not include the billing destination information, if the certificate authority 30 (billing process unit 36) manages, for example, billing destination information instructing a billing destination of the certificate issuance fee corresponding to the user who owns the edge device 10, the billing destination may be specified based on the billing destination information.

In particular, the first communication unit 31 has executed the user authentication process with the user terminals 20 (the certificate acquisition unit 26) in the step S3 described above, and stores the user IDs used in the user authentication process. In this case, the billing process unit 36 can acquire the user ID from the first communication unit 31 via the certificate issuance unit 34, for example, and specify the billing destination instructed by the billing destination information corresponding to the user ID. In other words, in the present embodiment, the billing process may be executed for the billing destination of the certificate issuance fee corresponding to the user (the user who owns the edge device 10) authenticated by executing the user authentication process, based on the billing destination information managed in the certificate authority 30.

In a case where the certificate signing request does not include the billing destination information and the billing destination information instructing the billing destination corresponding to the user who owns the edge device 10 is not managed in the certificate authority 30, even when the user is authenticated by the execution of the user authentication process, an error is notified from the certificate issuance unit 34 to the user terminal 20.

Referring to FIG. 9, the public key certificates of the edge devices 10 issued by the certification issuance unit 34 as described above are transmitted (provided) to the user terminals 20 via the first communication unit 31 (step S6).

When the process of the step S6 is executed, the public key certificates transmitted in the step S6 are received by the second communication unit 22 included in the user terminals 20, and the certificate acquisition unit 26 acquires the public key certificates from the second communication unit 22. The public key certificates acquired by the certification acquisition unit 26 are passed to the initial setting processing unit 25 and transmitted to the edge devices 10 via the first communication unit 21 (step S7).

When the process of the step S7 is executed, the public key certificates transmitted in the step S7 are received by the first communication unit 11 included in the edge devices 10, and the registration unit 16 acquires the public key certificates from the first communication unit 11. The public key certificate acquired by the registration unit 16 is registered (set) in the edge device 10. Thus, the initial setting of the edge device 10 is completed.

In step S7, setting information (for example, server information managed by the server information management unit 24) for the edge devices 10 to communicate with the server device 40 may be transmitted together with the public key certificates, and the setting information may be set in the edge devices 10.

When the public key certificates are registered in the edge devices 10 as described above, the edge devices 10 and the server device 40 perform the device authentication process using the public key certificates (step S8). In step S8, for example, a device authentication process may be executed to confirm whether the public key certificates presented from the edge devices 10 are the public key certificates legitimately issued for the public keys of the edge devices 10.

When the edge devices 10 are authenticated by the execution of the process in step S8, the application processing units 17 included in the edge devices 10 start the execution of application communication with the server device 40. The edge devices 10 and the server device 40 operate in cooperation with each other as an application system through such application communication, thereby realizing provision of the IoT service (step S9).

Here, although it has been described in FIG. 9 that the billing destination of the certificate issuance fee is specified based on the billing destination information included in the certificate signing request or the billing destination information managed in the certificate authority 30, it is assumed that the billing destination information (hereinafter, referred to as first billing destination information) is included in the certificate signing request and the billing destination information (hereinafter, referred to as second billing destination information) is managed in the certificate authority 30. In this case, when the billing destination instructed by the first billing destination information and the billing destination instructed by the second billing destination information are the same, the billing process may be executed for the billing destination. On the other hand, when the billing destination instructed by the first billing destination information and the billing destination instructed by the second billing destination information are different, it is necessary to specify the billing destination of the certificate issuance fee based on either one of the first and second billing destination information.

Specifically, in a case where priority information instructing that one of the first and second billing destination information is prioritized is set (held) in advance in the certificate authority 30, one of the first and second billing destination information is selected based on the priority information, and the billing destination of the certificate issuance fee can be specified based on the selected billing destination information.

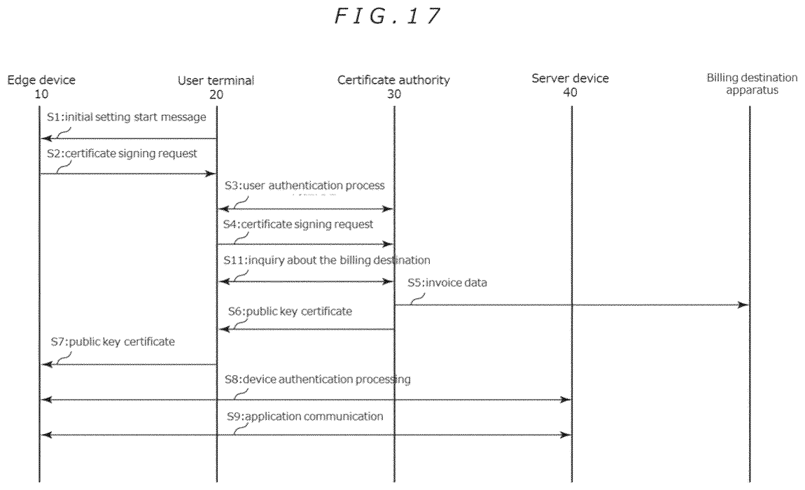

As shown in step S11 of FIG. 17, the user terminals 20 (users using the user terminals 20) may be inquired about the billing destinations of the certificate issuance fee during the processing of steps S4 and S5 shown in FIG. 9 described above. According to this, it is possible to execute the billing process for the billing destination specified based on the response to the query (the result of the query) in the step S11.

Further, in FIG. 9, it has been described that the billing process (that is, transmission of the invoice data) is executed after the public key certificate is issued and before the public key certificate is transmitted from the certificate authority 30 to the user terminal 20, but the billing process may be executed at a different timing. Specifically, the billing process may be executed at a timing when the verification of the certificate signing request is successful (a timing after it is confirmed that the public key certificate can be issued and before the public key certificate is issued), or may be executed after the public key certificate is transmitted from the certificate authority 30 to the user terminal 20.

It is also assumed that an expiration date is set for the public key certificate issued by the certificate authority 30 (certificate issuance unit 34), and the expiration date is managed by the certificate authority 30. In a case where the expiration date of the public key certificate set in this manner has expired, the edge device 10 cannot execute communication with the server device 40, and thus the certificate authority 30 may notify the billing destination of the fee for the issuance of the public key certificate of the update of the public key certificate (issued certificate) whose expiration date is close. The notification to the billing destination includes sending a message (email), for example, “The public key certificate of the device Y provided to the user X will expire in three months. Recommend early update.” Since updating of the public key certificate corresponds to issuing a new public key certificate, when updating the public key certificate, the same process as the process shown in FIG. 9 may be executed and the current public key certificate may be discarded.

Although a detailed description is omitted in FIG. 9, the key management unit 15 included in the edge device 10 may generate an electronic signature to be attached to the certificate signing request by using the secret key of the edge device 10 managed by the key management unit 15. The electronic signature is generated by, for example, performing encryption processing on the hash value of the certificate signing request using the secret key of the edge device 10.

In this case, a certificate signing request with an electronic signature attached thereto is transmitted from the edge device 10 to the user terminal 20, and the initial setting processing unit 25 included in the user terminal 20 can verify the certificate signing request using the electronic signature. In the verification of the certificate signing request, a process of calculating a hash value of the certificate signing request and collating the calculated hash value with a result (hash value) of performing an encryption process on the electronic signature attached to the certificate signing request using a public key (public key of the edge device 10) paired with the private key of the edge device 10 is executed. In this case, when the hash value of the certificate signing request and the hash value obtained from the electronic signature match, it can be confirmed that the certificate signing request has been successfully verified.

Although the above description has been made on the assumption that the electronic signature generated in the edge device 10 is attached to the certificate signing request transmitted from the edge device 10 to the user terminal 20, the electronic signature generated using the private key of the user terminal 20 may be attached to the certificate signing request transmitted from the user terminal 20 to the certificate authority 30. In this case, the request verification unit 33 included in the certificate authority 30 can verify the certificate signing request by using the electronic signature attached to the certificate signing request transmitted from the user terminal 20 and the public key of the user terminal 20. According to this, it is possible to confirm that the edge device 10 has generated the certificate signing request by the instruction of the user terminal 20.

Further, an electronic signature generated using the private key of the certificate authority 30 may be attached to the public key certificate transmitted from the certificate authority 30 to the user terminal 20. In this case, the certificate acquisition unit 26 included in the user terminal 20 can verify the public key certificate by using the electronic signature attached to the public key certificate transmitted from the certificate authority 30 and the public key of the certificate authority 30. Note that the verification of the public key certificate may be performed by the registration unit 16 included in the edge device 10, for example.

Note that the process shown in FIG. 9 is an example, and in the present embodiment, a process that is partially different from the process described in FIG. 9 may be executed, or a process in which a portion of the process described in FIG. 9 is omitted may be executed.

As described above, in the present embodiment, the edge device 10 (communication device) transmits, to the user terminal 20 (terminal device), a certificate signing request for requesting issuance of a public key certificate (a certificate for a public key of the edge device 10 in the public key encryption scheme) used for the edge device 10 to execute communication with the server device 40 (first server device). In the present embodiment, the user terminal 20 transmits the certificate signing request transmitted from the edge device 10 to the certificate authority 30. Furthermore, in the present embodiment, the certificate authority 30 issues a public key certificate in response to a certificate signing request transmitted from the user terminal 20 and executes a billing process for billing for a certificate issuance fee (fee for issuance of the certificate).

In the present embodiment, with the above-described configuration, it is possible to easily issue a public key certificate (a public key certificate used by the edge device 10 for communication) for the edge device 10 in a factory shipment state.

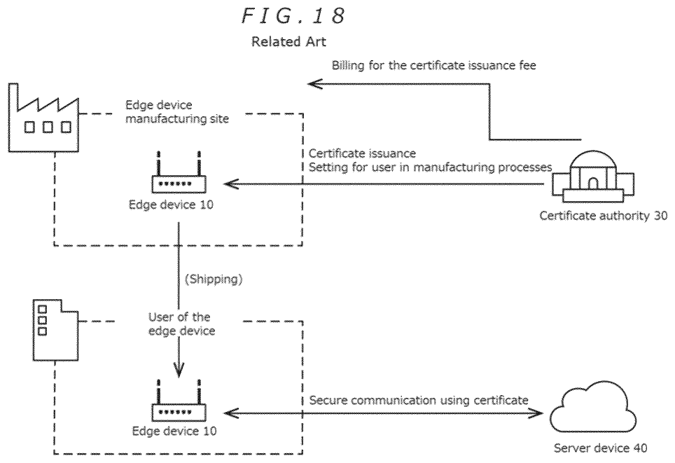

FIG. 18 shows an outline of issuance of a public key certificate in a comparative example. As illustrated in the comparative example of FIG. 18, the setting for the user such as the registration of the public key certificate issued from the certificate authority 30 is completed in the manufacturing site of the edge device 10, and the user can perform communication (secure communication using the certificate) with the server device 40 using the edge device 10 in which the public key certificate is already registered.

However, in the comparative example described above, since the public key certificate is registered in advance in the edge device 10 before being shipped from the factory, for example, the public key certificate cannot be issued in the certificate authority 30 designated by the user. Furthermore, when issuing and registering the public key certificate in advance, it takes time to ship the edge device 10.

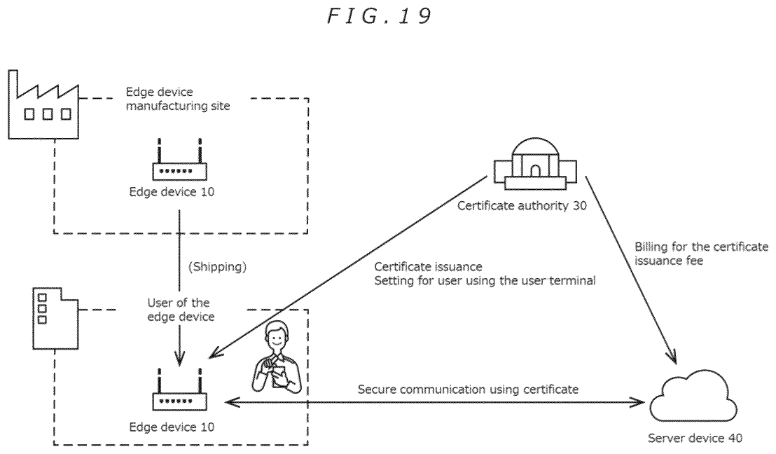

On the other hand, FIG. 19 shows an outline of issuance of a public key certificate in this embodiment. As illustrated in FIG. 19, in the present embodiment, after the edge device 10 for which the public key certificate is not issued and registered in advance is shipped from the factory, the public key certificate of the edge device 10 in the factory shipment state is issued and registered using the user terminal 20.

According to such a configuration, unlike the comparative example described above, the certificate authority 30 designated by the user who owns the edge device 10 (the user who uses the user terminal 20) can be used for issuing and registering the public key certificate.

Furthermore, in the present embodiment, it is not necessary to perform setting for connecting the edge device 10 to the certificate authority 30 in relation to the issuance of the public key certificate, and it is possible to automate the issuance and registration (that is, initial setting) of the public key certificate of the edge device 10 in a factory shipment state. That is, in the present embodiment, since there is no need for specialized knowledge or complicated work relating to the issuance and registration of a public key certificate, it is possible to reduce the time and effort of the user (that is, it is possible to easily perform initial setting including the issuance and registration of a public key certificate).

In addition, in the present embodiment, since it is not necessary to complete the setting for the user such as the issuance and registration of the public key certificate before the factory shipment, it is possible to contribute to the quick shipment of the edge device 10.

Further, in the comparative example of the present embodiment illustrated in FIG. 18, since the edge device 10 is not delivered at the time when the public key certificate is issued, the certificate issuance fee is billed to, for example, the manufacturer of the edge device 10. In contrast, in the present embodiment shown in FIG. 19, the certificate issuance fee can be billed to, for example, the server administrator or the like.

That is, in the present embodiment, it is possible to execute the billing process for various billing destinations according to the user or the executor of the communication system 1, as compared with the comparative example of the present embodiment.

In the present embodiment, it is assumed that the certificate signing request includes billing destination information instructing a billing destination of the certificate issuance fee, and the certificate authority 30 executes billing process to the billing destination of the certificate issuance fee instructed by the billing destination information included in the certificate signing request. In this case, the edge device 10 generates a certificate signing request including, for example, billing destination information managed in the edge device 10, but the billing destination may be instructed based on information held in the user terminal 20 or may be instructed by the user who owns the edge device 10 (that is, information input to the user terminal 20 by the user).

When the certificate signing request does not include the billing destination information, the certificate authority 30 may perform the billing process for the billing destination of the certificate issuance fee corresponding to the user who owns the edge device 10 (the user authenticated by performing the user authentication process).

Further, when the billing destination instructed by the billing destination information included in the certificate signing request is different from the billing destination corresponding to the user who owns the edge device 10, the certificate authority 30 may inquire of the user about the billing destination of the certificate issuance fee and execute the billing process based on the result of the inquiry.

In the present embodiment, the certificate issuance fee, the timing of billing the certificate issuance fee, and the method of paying the certificate issuance fee may be different depending on the billing destination of the certificate issuance fee. In the present embodiment, with the above described configuration, it is possible to execute appropriate billing process when the public key certificate of the edge device 10 is issued after factory shipment.

Here, a specific application example of the communication system 1 according to the present embodiment will be briefly described. A case where the edge device 10 is a MultiFunction peripheral (MFP) installed in an office or the like is considered. Further, for example, it is assumed that a maintenance person of the MFP uses an edge terminal corresponding to the user terminal 20 and performs initial setting of the MFP in an office or the like where the MFP is installed. In this case, the public key certificate of the MFP can be issued using the communication system 1 according to the present embodiment.

As described above, the certificate issuance fee in a case where the public key certificate is issued may be billed to, for example, a company that is a manufacturer of the MFP, a provider of a cloud service (IoT service) with which the MFP cooperates, or an end user of the MFP (a company that actually uses the MFP in an office or the like).

According to the present embodiment, the billing destination of the certificate issuance fee is specified based on the billing destination information, but for example, in a case where there are a plurality of pieces of the billing destination information (that is, the certificate signing request includes the billing destination information, and the billing destination information is managed in the certificate authority 30), a message such as “Which side do you want to bill the fee next?” is pop-up displayed on the edge terminal possessed by the maintenance person, and it is possible to allow the maintenance person who uses the edge terminal to select one of the company that is the manufacturer of the MFP, the provider of the cloud service, and the end user.

Although the MFP has been described as an example of the edge device 10, the communication system 1 according to the present embodiment is applicable to a case where an IoT service is provided using various edge devices 10.

In the present embodiment, the user terminal 20 instructs the edge device 10 to generate a certificate signing request when the edge device 10 and the user terminal 20 are communicably connected, and the edge device 10 generates a certificate signing request in response to the instruction from the user terminal 20, thereby enabling the certificate authority 30 to issue a public key certificate using the user terminal 20.

Furthermore, in the present embodiment, the user terminal 20 transmits user information of a user who owns the edge device 10 (a user who uses the user terminal 20) and server information of the server device 40 to the edge device 10, and with the configuration in which the user information and the server information transmitted from the user terminal 20 are set in the edge device 10, it is possible to automatically perform the setting of the edge device 10 based on the information provided from the user terminal 20. In the present embodiment, the user may designate the server device 40 (cloud system) or the like with which the edge device 10 cooperates, in addition to the above described certificate authority 30.

In the present embodiment, the certificate authority 30 verifies the certificate signing request based on, for example, the device information included in the certificate signing request, and issues the public key certificate when the verification of the certificate signing request is successful. According to such a configuration, it is possible to issue a public key certificate of a valid edge device 10.

The certificate signing request may be verified using an electronic signature attached to the certificate signing request. According to such a configuration, for example, it is possible to avoid a situation in which a public key certificate is issued in response to a certificate signing request that has been tampered with or the like, and it is possible to reduce security risks in the IoT service.

Although the verification of the certificate signing request has been described above, the verification of the public key certificate issued from the certificate authority 30 may be performed using, for example, an electronic signature attached to the public key certificate (an electronic signature generated by the certificate authority 30). In addition, in the present embodiment, by executing the user authentication process for the user who owns the edge device 10 between the user terminal 20 and the certificate authority 30, it is possible to issue a public key certificate in response to a request from a valid user.

Further, in the present embodiment, whether or not to issue a public key certificate may be determined based on issue history information relating to public key certificates issued in the past. According to such a configuration, for example, it is possible to avoid the occurrence of a situation in which the communication system 1 does not operate normally due to issuing a plurality of certificates for the same public key. Further, by using the issuance history information described above, it is possible to prevent a replay attack such as erroneous issuance of a public key certificate or transmission of the same certificate signing request to the certificate authority 30 a plurality of times.

In addition, in the present embodiment, as described above, since the communication with the server device 40 is executed in a case where the edge device 10 is authenticated by executing the device authentication process on the edge device 10 using the public key certificate registered in the edge device 10, it is possible to provide the IoT service with a reduced security risk.

Note that the present embodiment may be configured to be able to realize the issuance of the public key certificate of the edge device 10 in the factory shipment state using the user terminal 20, and for example, a part of the configurations of the communication system 1, the edge device 10, the user terminal 20, and the certificate authority 30 described in the present embodiment may be omitted, or other configurations may be added.

### Second Embodiment

Next, another embodiment will be described. In this embodiment, detailed description of the same parts as those in the first embodiment described above will be omitted, and parts different from those in the first embodiment will be mainly described.

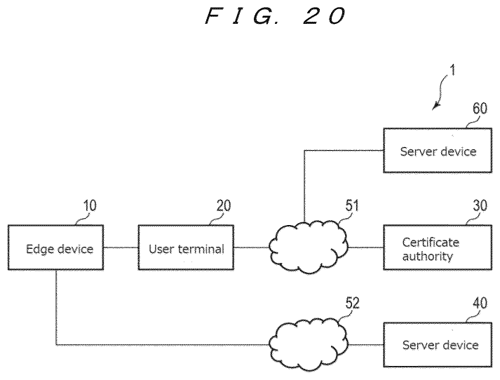

FIG. 20 shows an example of a system configuration of a communication system according to the present embodiment. As shown in FIG. 20, the communication system 1 further includes a server device 60 different from the server device 40, as compared with the first embodiment described above. In the present embodiment, for convenience of description, the server device 40 illustrated in FIG. 20 is described as a first server device 40, and the server device 60 is described as a second server device 60.

The second server device 60 is configured to execute a user authentication process for a user who owns the edge device 10 (a user who uses the user terminal 20).

The user terminal 20 and the second server device 60 illustrated in FIG. 20 are communicably connected to each other via a network 51.

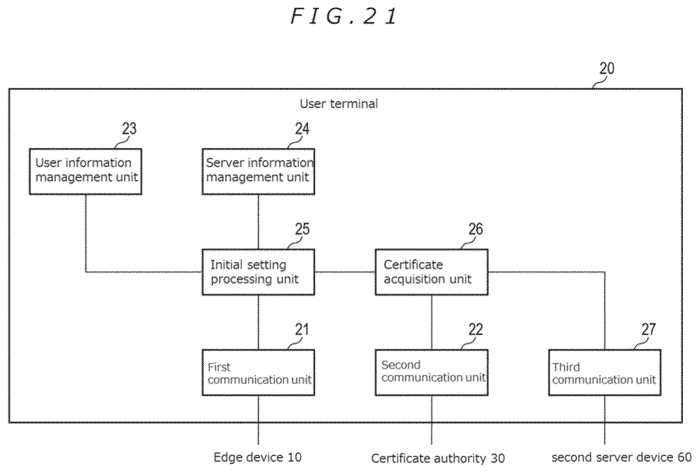

FIG. 21 shows an example of a functional configuration of the user terminal 20 in the present embodiment. As shown in FIG. 21, the user terminal 20 further includes a third communication unit 27, as compared with the first embodiment described above.

The third communication unit 27 communicates with the second server device 60 via the network 51. Note that, although the first communication unit 21, the second communication unit 22, and the third communication unit 27 are shown as independent and separate functional units in FIG. 19, the first communication unit 21, the second communication unit 22, and the third communication unit 27 may be realized as a single functional unit. The communication scheme for the first communication unit 21 to perform communication, the communication scheme for the second communication unit 22 to perform communication, and the communication scheme for the third communication unit 27 to perform communication may be different from each other or may be the same.

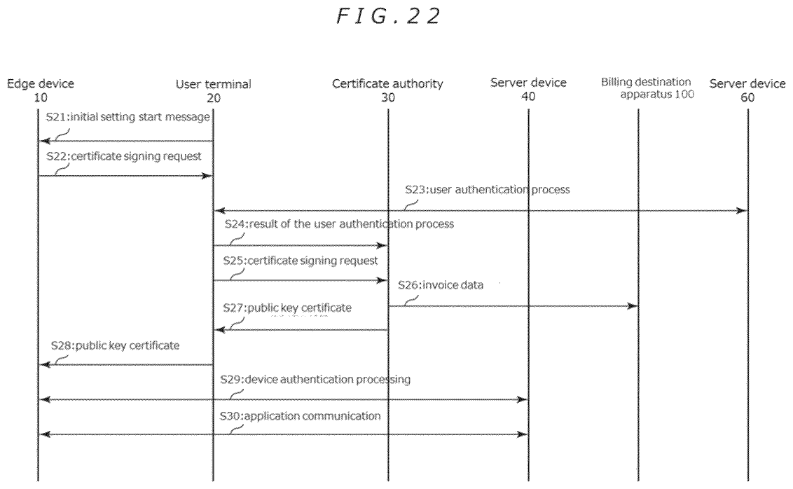

Hereinafter, an example of a processing procedure of the communication system 1 according to the present embodiment will be described with reference to a sequence chart of FIG. 22.

First, the processing of steps S11 and S12 corresponding to the processing of steps S1 and S2 shown in FIG. 9 described above is executed.

In the first embodiment described above, the user authentication process is performed between the user terminal 20 (certificate acquisition unit 26) and the certificate authority 30. In the present embodiment, however, the second server device 60 performs the user authentication process instead of the certificate authority 30.

In this case, the certification acquisition unit 26 included in the user terminal 20 executes the user authentication process with the second server device 60 (step S23).

Since the user authentication process is as described in the first embodiment, the detailed description thereof will be omitted here, but in the present embodiment, a case is assumed in which the user authentication process is executed in the second server device 60 for providing another service different from the IoT service described above using the user ID and the password associated with the account of the other service.

Further, there is a case where a process of exchanging a message for starting the certification issuing process between the user terminal 20 and the certification authority 30 is inserted between the steps S22 and S23, but the detailed description thereof will be omitted.

When the process of step S23 is executed, the certification acquisition unit 26 transmits the result of the user authentication process to the certificate authority 30 via the second communication unit 22 (step S24).

When the user is authenticated based on the result of the user authentication process transmitted in step S24, the process of steps S25 to S30 corresponding to the process of steps S4 to S9 shown in FIG. 9 described above is executed.

In the first embodiment described above, for example, when the certificate signing request does not include the billing destination information, the billing process is executed for the billing destination of the certificate issuance fee corresponding to the user authenticated by the user authentication process executed by the certificate authority 30, but in the present embodiment, the billing process may be executed for the billing destination of the certificate issuance fee corresponding to the user authenticated by the user authentication process executed by the second server device 60.

In the present embodiment, the second server device 60 performs the user authentication process by the certificate authority 30 instead of the certificate authority 30, and thus, for example, the processing load of the certificate authority 30 can be reduced, or the certificate authority 30 does not need to manage the authentication information of the user.

In the present embodiment described above, the user authentication process is executed between the user terminal 20 and the second server device 60. However, the user authentication process may be executed by, for example, the certificate authority 30 transferring a request for user authentication from the user terminal 20 to the second server device 60 (that is, the certificate authority 30 requesting the second server device 60 to execute the user authentication process). The user authentication process may be executed using, for example, OAuth2 authentication and authorization or the OpenID Connect mechanism.

Further, in the present embodiment, for example, a part of the configuration of the certificate authority 30 described in the first embodiment may be arranged in the second server device 60. Specifically, for example, the verification information management unit 32 included in the certificate authority 30 may be arranged in the second server device 60. According to such a configuration, for example, when the user is authenticated by executing the user authentication process between the user terminal 20 and the second server device 60, the verification information is provided from the second server device 60 to the certificate authority 30, and the certificate authority 30 can verify the certificate signing request based on the verification information provided from the second server device 60.

According to at least one of the embodiments described above, it is possible to provide a communication system, a certificate authority, and a method capable of easily issuing a certificate used for communication.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. These embodiments and modifications thereof are included in the scope and spirit of the invention, and are also included in the subject matter described in the claims and the scope of equivalents thereof.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The disclosure includes a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

What is claimed is:

1. A communication system, comprising:
communication circuitry;
a terminal; and
certificate authority circuitry,
wherein:
the communication circuitry includes circuitry configured to transmit a certificate signing request to the terminal, the certificate signing request requesting issuance of a certificate used by the communication circuitry to execute communication with a first server,
the terminal includes circuitry configured to transmit the certificate signing request transmitted from the communication circuitry to the certificate authority circuitry, and
the certificate authority circuitry includes circuitry configured to issue the certificate in response to a certificate signing request transmitted from the terminal.

2. The communication system according to claim 1, wherein:
The certificate authority circuitry further includes circuitry configured to execute a billing process for billing for the issue of the certificate.

3. The communication system according to claim 2, wherein:
the certificate signing request includes billing destination information instructing a billing destination of a fee, and
the certificate authority circuitry further includes circuitry configured to execute the billing process for a billing destination of the fee instructed by billing destination information included in the certificate signing request.

4. The communication system according to claim 3, wherein:
the communication circuitry is configured to generate a certificate signing request including billing destination information managed in the communication circuitry.

5. The communication system according to claim 4, wherein:
the billing destination of the fee is instructed based on information stored in the terminal.

6. The communication system according to claim 4, further comprising:
receiving circuitry configured to receive the billing destination of the fee from a user who owns the communication circuitry.

7. The communication system according to claim 2, wherein:
the certificate authority circuitry further includes circuitry configured to execute the billing process for a billing destination of the fee corresponding to a user who owns the communication circuitry.

8. The communication system according to claim 2, wherein:
the certificate signing request includes billing destination information instructing a billing destination of the fee, and
when the billing destination of the fee is instructed by the billing destination information included in the certificate signing request is different from the billing destination of the fee corresponding to a user who owns the communication circuitry, the certificate authority circuitry inquires the user about the billing destination of the fee and executes the billing process based on a result of the inquiry.

9. The communication system according to claim 7, wherein:
the certificate authority circuitry executes an authentication process for a user who owns the communication circuitry with the terminal.

10. The communication system according to claim 7, wherein:
the terminal is communicably connected to a second server, and
the second server executes an authentication process for a user who owns the communication circuitry with the terminal.

11. The communication system according to claim 3, wherein:
the fee is different depending on a billing destination of the fee.

12. The communication system according to claim 3, wherein:
the billing timing of the fee is different depending on a billing destination of the fee.

13. The communication system according to claim 3, wherein:
the payment method of the fee is different depending on a billing destination of the fee.

14. A certificate authority communicably connected to a terminal, the certificate authority comprising:
a receiver configured to receive a certificate signing request from the terminal when the certificate signing request for requesting issuance of a certificate used for communication circuitry to execute communication with a first server is transmitted from the communication circuitry to the terminal; and
issuing circuitry configured to issue the certificate in response to the received certificate signing request.

15. The certificate authority according to claim 14, further comprising:
billing process circuitry configured to execute billing process for billing a fee for issuance of the certificate.

16. A method, comprising:
transmitting a certificate signing request for requesting issuance of a certificate used by communication circuitry to execute communication with a first server from the communication circuitry to a terminal;
transmitting, from the terminal to a certificate authority circuitry, the certificate signing request transmitted from the communication circuitry; and
issuing the certificate in response to a certificate signing request transmitted from the terminal.

17. The method according to claim 16, further comprising:
executing a billing process for billing a fee for the issuance of the certificate.

18. A method, comprising:
receiving a certificate signing request when the certificate signing request for requesting issuance of a certificate used for a communication circuitry to execute communication with a first server is transmitted from the communication circuitry to a terminal;
issuing the certificate in response to the received certificate signing request.

19. A method according to claim 18, further comprising:
executing a billing process for billing a fee for the issuance of the certificate.
